(19) United States
(12) Patent Application Publication
(10) Pub. No.: US 2007/0006140 A1
(43) Pub. Date: Jan. 4, 2007

(54) System and apparatus to extend stack allocation

(76) Inventors: Guei-Yuan Lueh, San Jose, CA (US); Gansha Wu, Beijing (CN); Xiaohua Shi, Beijing (CN)

Correspondence Address: TROP PRUNER & HU, PC, 1616 S. VOSS ROAD, SUITE 750, HOUSTON, TX, 77057-2631, US

(21) Appl. No.: 11/172,211

(22) Filed: Jun. 29, 2005

(51) Int. Cl. G06F 9/44

(52) U.S. Cl. 717/108

(57) ABSTRACT

A technique includes generating frames on a stack for a chain of callers. Each frame corresponds to one of the callers, and at least some of the callers use an object that survives at least one but not all of the callers. The technique includes retaining at least one of the frames on stack after the corresponding caller ceases to exist.

### BACKGROUND

The invention generally relates to a technique to extend stack allocation.

Dynamic object allocation strategy is an important topic in object oriented programming language (OOPL) design. Some languages like Java, for example, support heap allocation and do not support stack allocation. Other multi-paradigm languages, such as C# and C++, permit both heap and stack allocation. Stack allocation allocates objects on the call stack instead of on the heap; and the allocation and de-allocation typically are performed quickly by adding or subtracting the size of the block from the stack pointer. As a result, it is often desirable to allocate objects on the stack rather than on the heap.

Conventionally, some objects are not eligible to stay on the stack. This scenario typically occurs when an object survives (or as alternatively called “escapes”) its home method. Therefore, a frame for such a method typically is not allocated on the stack due to the escaping object.

Thus, there exists a continuing need for an arrangement and/or technique to allocate space on a stack for software method(s) that reference an escaping object.

### BRIEF DESCRIPTION OF THE DRAWING

FIG. 1 is a diagram depicting a flow of an object oriented method.

FIG. 2 depicts an exemplary call chain in accordance with an embodiment of the invention.

FIG. 3 depicts a stack generated by the call chain of FIG. 2 according to an embodiment of the invention.

FIG. 4 depicts another exemplary call chain according to an embodiment of the invention.

FIG. 5 is a flow diagram depicting a technique to extend stack allocation according to an embodiment of the invention.

FIG. 6 depicts a stack generated by the call chain of FIG. 5 according to an embodiment of the invention.

FIG. 7 depicts the stack of FIG. 6 after its associated method exits according to an embodiment of the invention.

FIG. 8 is a flow diagram depicting a technique to generate frames on the stack according to an embodiment of the invention.

FIG. 9 is a block diagram of a computer system in accordance with an embodiment of the invention.

### DETAILED DESCRIPTION

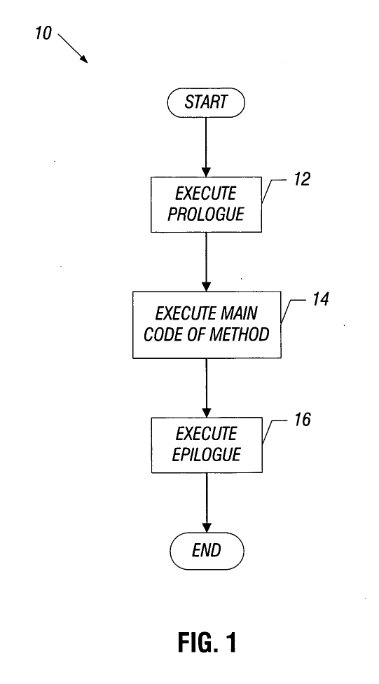

Referring to FIG. 1, an object oriented method (herein abbreviated as “method”), in general, transitions through a flow 10 from its creation to its expiration. As described further below, the flow 10 is modified for some methods for purposes of extending the stack life of frames to account for handling objects (herein referred to as “escapees”) that escape their home method.

In its unmodified version, the flow 10 includes, in general, executing (block 12) a prologue. The prologue, among other things, allocates a new frame on the call stack for the method as well as allocates local variables that are used by the method. Next, the main code of the method is executed, as depicted in block 14. Upon exiting, an epilogue may be executed, pursuant to block 16, for purposes of de-allocating the stack frame. Thus, in general, when a method completes executing its main program code, the method de-allocates or removes, its corresponding frame from the stack. This is often referred to as “popping” the frame from the stack.

As described below, contrary to the flow 10, in accordance with some embodiments of the invention, a method that contains an escapee does not execute an epilogue. In other words, the method does not remove its corresponding frame from the call stack when the method exits; but instead, the frame is retained on the stack until the escapee expires, or ceases to exist.

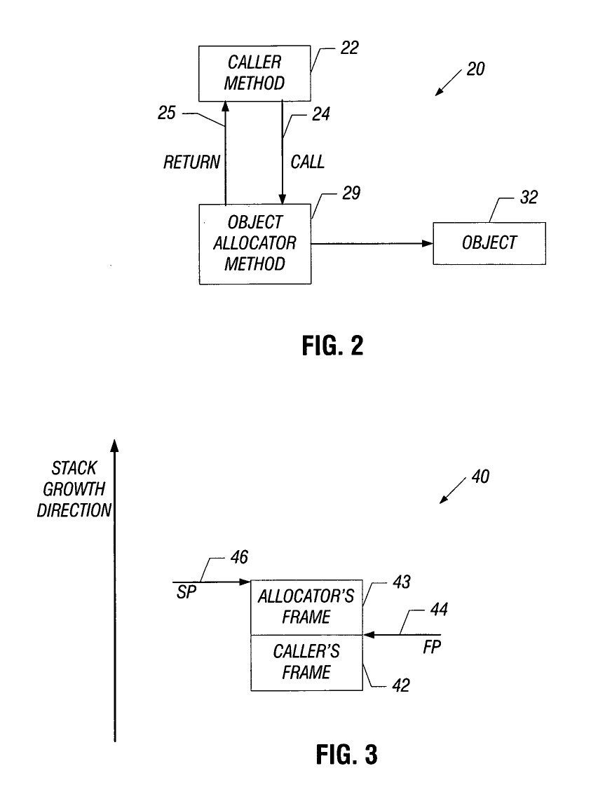

As a more specific example, FIG. 2 depicts an exemplary call chain 20, illustrating a caller method 22 (or as alternatively labeled “caller”) that makes a call 24 to an object allocator method 29. When the main code of the allocator 29 is executed, the allocator method 29 creates an object 32. The object 32, for this example, survives, or escapes, the allocator method 29. In other words, when the allocator method 29 exits, the object 32 still exists. For example, the caller method 22 may reference and use the object 32 after the allocator method 29 exits (as indicated by a return 25). Thus, the object 32 may be referred to as an “escapee.” The object 32, in this example, does not escape the caller method 22, as when the caller method 22 exits, the object 32 no longer exists. The object 32 is called herein a “restrained escapee,” a term that means that object 32 escapes its creating home method (i.e., the allocator method 29); however, the object 32 eventually ceases to exist when a particular method, such as the caller method 22 (for this example), exits.

Referring to FIG. 3 in conjunction with FIG. 2, in some embodiments of the invention, the caller method 22 and the allocator method 29 allocate frames on a stack 40 in the following manner. First, upon creation of the caller method 22, a corresponding caller's frame 42 is formed on the stack 40. Next, upon the call 24 to the allocator method 29, a corresponding allocator's frame 43 is formed on the stack 40. This particular state is depicted in FIG. 3 in that the caller's frame 42 exists below the allocator's frame 43 on the stack 40.

Also depicted in FIG. 3 are a stack pointer 46 and a frame pointer 44. The stack pointer 46 points to the top of the stack 40. The frame pointer 44, in contrast to the stack pointer 46, points to a particular location of a frame in the stack 40. Quite often, the stack pointer 46 and the frame pointer 44 may point to the same address. However, as described further below, in accordance with some embodiments of the invention, the frame pointer 44 may point to a different location than the stack pointer 46. This feature is used to address data concerning the object 32 that may exist in an otherwise “dead” or retained frame (i.e., a frame whose associated method has exited). As previously noted, in accordance with embodiments of the invention that are described herein, if a particular frame includes a restrained escapee, then the frame is retained on the stack after its associated method has exited.

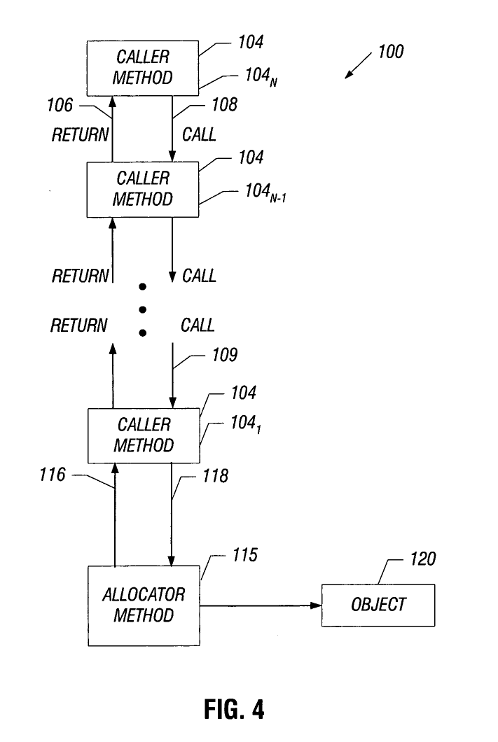

To further illustrate the retention of frames on the stack for a restrained escapee, in accordance with embodiments of the invention, FIG. 4 depicts an exemplary call chain 100. The call chain 100 includes N caller methods 104 (caller methods 104₁, 104_{N-1} . . . 104_{N}, depicted as examples) and an allocator method 115. As show, the caller method 104_{N} calls (at 108) the caller method 104_{N-1}; and the call chain 100 continues until the caller method 104₂ (not shown in FIG. 4) places a call (at 109) to the caller method 104₁. The caller method 104₁ makes a call (at 118) to the allocator method 115. The allocator method 115, in turn, creates an object 120, an object that survives the allocator method 115 as well as the caller methods 104₁ to 104_{N-1}.

After the allocator method 115 creates the object 120, a return (at 116) is made to the caller 104₁; and then, successive returns are made until a return (at 106) is made from the caller 104_{N-1} to the caller 104_{N}. In accordance with the embodiments of the invention that are described herein, although the caller methods 104_{N} to 104_{N-1} exit, their corresponding frames on the call stack are not de-allocated until the caller method 104_{N} exits.

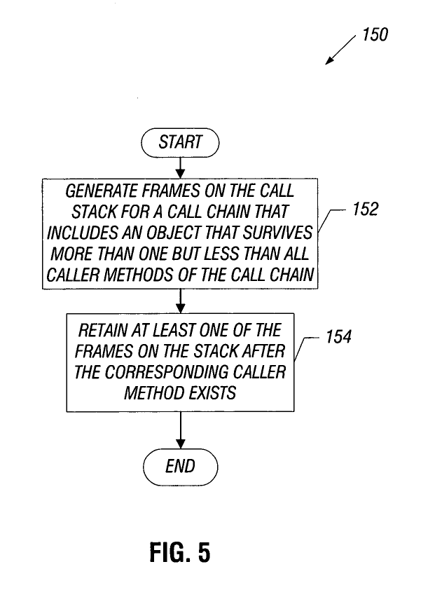

Thus, referring to FIG. 5, an embodiment of a technique 150 in accordance with the invention includes generating (block 152) frames on a call stack for a call chain that includes an object that survives more than one but less than all caller methods of the chain. At least one of the frames is retained (block 154) on the stack after the corresponding caller method exits.

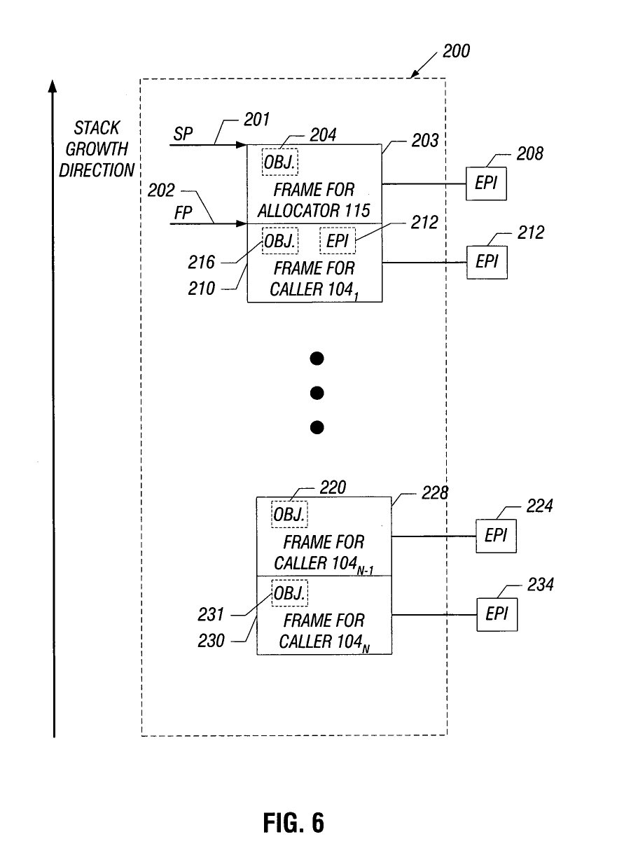

FIG. 6 depicts an exemplary stack 200 that is created by the call chain 100 of FIG. 4 right after the allocator method 115 creates the object 120 but before the allocator method 115 exits. Referring to FIG. 4 in conjunction with FIG. 6, to create the caller method 104_{N}, a corresponding frame 230 is allocated on the stack 200. The frame 230 includes memory space 231 for the object 120, and the frame 230 is associated with an epilogue 234 for the caller method 104_{N}. The epilogue 234 contains a command to “pop” the stack 200 to de-allocate the frames that are associated with the call chain 100 from the stack 200.

When the caller method 104_{N-1} is created, a corresponding frame 228 is created on the stack 200. Similar to the frame 230, the frame 228 includes memory space 220 for the object 120, and the frame 228 is associated with an epilogue 224. The epilogue 224, unlike the epilogue 234, however, does not pop the frame 228 off of the stack 200 after the caller method 104_{N-1} exits.

The above-described retention of the frames for the call chain 100 continues on the stack 200 for the frames that correspond to the caller methods 104_{N-2} to 104₁. Thus, a frame 210 for the caller method 104₁, as depicted in FIG. 6, includes stack space 216 for the object 120 and is also associated with an epilogue 212 that does not pop the frame 210 off of the stack 200 after the caller method 104₁ exits. Similarly, as depicted in FIG. 6, the stack 200 includes a frame 203. The frame 203 is created upon creation of the allocator method 115. Similar to the above-described frames 210 and 228, the frame 203 includes stack space 204 for the object 120 and is associated with an epilogue 208, which does not pop the frame 203 when the allocator method 115 exits.

Due to the above-described frames and their associated epilogues, the frames are de-allocated from the stack 200 in the following manner. First, the frames are created from the frame 230 until the frame 203 due to the progression of the call chain 100 from the caller method 104_{N} to the allocator method 115. When the allocator method 115 exits, the frame 203 is retained on the stack 200. This retention continues through the exiting of the caller method 104_{N-1} in which the frame 228 is retained on the stack 200.

However, when the caller method 104_{N} exits, the corresponding epilogue 234 pops the stack to reset a stack pointer 201 to remove the frame 230, as well as the retained “dead” frames from the stack 200.

As also depicted in FIG. 6, the stack 200 may have an associated frame pointer 202 for purposes of accessing the object 120 (FIG. 4) within the stack 200. Thus, the frame pointer 202 may be used to, for example, access data for the object (i.e., access object data such as object data 216, 220 and 231) from retained frames of the stack 200.

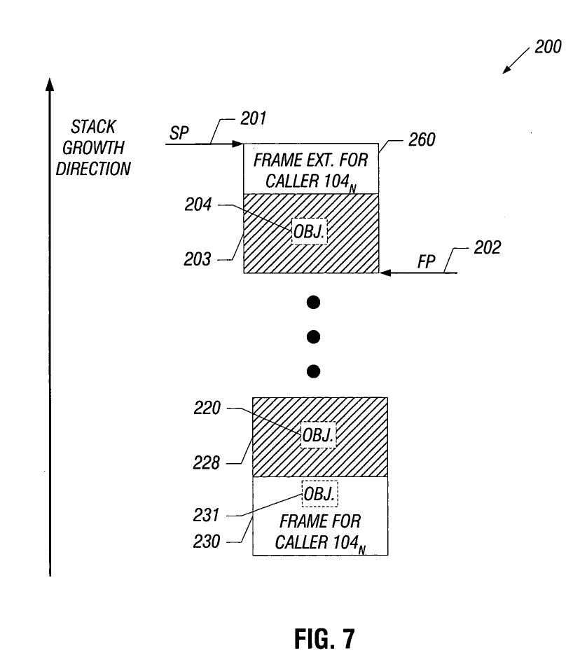

As a more specific example, referring to FIG. 7 in conjunction with FIGS. 4 and 6, the stack 200 may have retained, or “dead,” frames (indicated by the cross-hatching in FIG. 7) after all of the frames that are associated with the call chain 100 exit but before the frame 230 for the caller method 104_{N} exits. In FIG. 7, the frame 230 is still “alive” in that the caller method 104_{N} still exists. Upon returning to the caller method 104_{N}, the caller method 104_{N} may need to allocate additional stack space. To accomplish this and still retain the dead frames on the stack 200, in accordance with embodiment of the invention, an additional frame 260, called a “frame extension” herein, is created on the top of the stack 200. Thus, the frame 230 and the frame extension 260 are separated by the retained, or “dead,” frames in between.

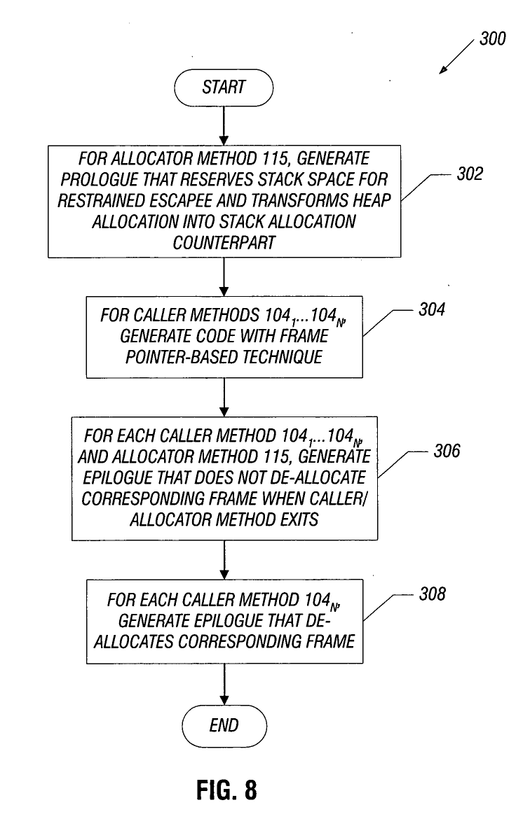

As a more specific example, FIG. 8 depicts a technique 300 that is performed by a compiler in accordance with some embodiments of the invention. Referring to FIG. 8 in conjunction with FIG. 4 (that depicts the call chain 100), pursuant to the technique 300, for an allocator method that creates restrained escapee, the compiler generates (block 302) a prologue that reserves stack space for the restrained escapee and transforms the heap allocation primitive into the stack allocation counterpart. Next, the compiler, for each caller method 104₁ to 104_{N}, generates (block 304) code using a frame pointer-based technique. Thus, the frame pointer is used in that the retained frames on the stack do not permit the use of the stack pointer. For each caller method 104_{N} to 104_{N-1} and the allocator method 115, the compiler generates (block 306) an epilogue that does not de-allocate the corresponding frame. Furthermore, for the caller method 104_{N}, the compiler generates (block 308) the epilogue that de-allocates the corresponding frame as well as pops the retained frames from the stack.

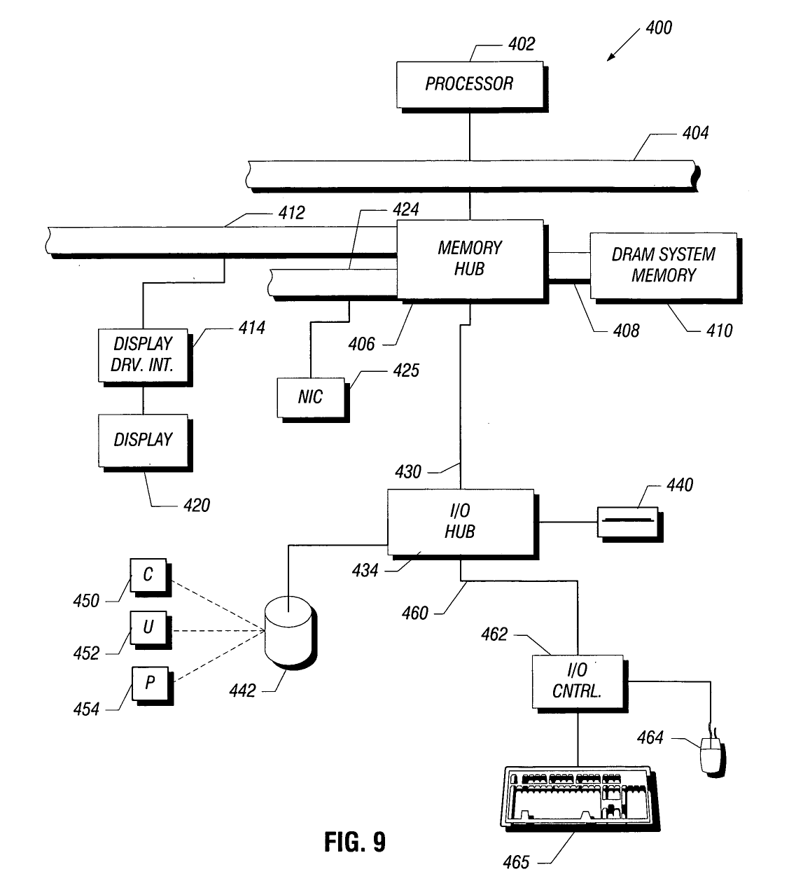

FIG. 9 depicts a schematic diagram of a computer system 400 (a desktop computer, laptop computer, server, etc., as just a few examples) in accordance with some embodiments of the invention, although other embodiments are within the scope of the appended claims.

The computer system 400 includes a processor 402 (one or more microprocessors, for example) that is coupled to a local, or system bus 404. A north bridge, or memory hub 406, is also coupled to the local bus 404 and establishes communication between the processor 402, a system memory bus 408, an Accelerated Graphics Port (AGP) bus 412 and a Peripheral Component Interconnect (PCI) bus 424. The AGP Specification is described in detail in the Accelerated Graphics Port Interface Specification, Revision 1.0, published on Jul. 31, 1996, by Intel Corporation of Santa Clara, Calif. The PCI Specification is available from The PCI Special Interest Group, Portland, Oreg. 97214.

A system memory 410 (such as a dynamic random access memory (DRAM), for example) is coupled to the system memory bus 408 and may store copies of compiler program code 450, uncompiled program code 452 and compiled program code 454 (all which may be stored on a hard drive 442 of the computer system 400), depending on the particular embodiment of the invention. The compiler program 450 may, for example, when executed by the processor 402, cause the computer system 400 to perform the technique 300 that is depicted in FIG. 8.

Still referring to FIG. 9, among its other features, the computer system 400 may include a display driver interface 414 that couples a display 420 to the AGP bus 412. Furthermore, a network interface card (NIC) 425 may be coupled to the PCI bus 424 in some embodiments of the invention. A hub link 430 may couple the memory hub 406 to a south bridge, or input/output (I/O) hub 434. The I/O hub 434 may provide interfaces for the hard disk drive 442 and a CD-ROM drive 440, for example. Furthermore, the I/O hub 434 may provide an interface to an I/O expansion bus 460. An I/O controller 462 may be coupled to the I/O expansion bus 460 and provide interfaces for receiving input data from a mouse 464 as well as a keyboard 465.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A method comprising:
generating frames on a stack for a chain of callers, each frame corresponding to one of the callers and at least some of the callers using an object that survives at least one but not all of the callers; and
retaining at least one of the frames on the stack after the corresponding caller ceases to exist.

2. The method of claim 1, wherein all of the frames store data indicative of the object and the retaining comprises retaining all of the frames until a final caller of the chain ceases to exist.

3. The method of claim 1, further comprising:
generating another frame on the stack for an allocator that creates the object.

4. The method of claim 4, further comprising:
retaining said another frame on the stack after the allocator ceases to exist.

5. The method of claim 1, further comprising:
forming an extension of the stack for the allocator.

6. The method of claim 5, wherein the act of forming the extension comprises:
including retained frames between an initial frame on the stack for the allocator and an extension frame for the allocator.

7. The method of claim 1, wherein the retaining comprises:
executing at least one prologue that fails to de-allocate stack space for one of the frames in response to the corresponding caller exiting.

8. An article comprising a computer accessible storage medium storing instructions that when executed cause the computer to:
generate frames on a stack for a chain of callers, each frame corresponding to one of the callers and at least some of the callers using an object that survives at least one but not all of the callers; and
retain at least one of the frames on the stack after the corresponding caller ceases to exist.

9. The article of claim 8, wherein all of the frames store data indicative of the object, the storage medium storing instructions to cause the computer to retain all of the frames until a final caller of the chain ceases to exist.

10. The article of claim 8, the storage medium storing instructions to cause the computer to generate another frame on the stack for an allocator that creates the object.

11. The article of claim 9, the storage medium storing instructions to cause the computer to retain said another frame on the stack after the allocator ceases to exist.

12. The article of claim 9, the storage medium storing instructions to cause the computer to form an extension of the stack for the allocator.

13. The article of claim 9, the storage medium storing instructions to cause the computer to include retained frames between an initial frame on the stack for the allocator and an extension frame for the allocator.

14. A system comprising:
a processor; and
a dynamic random access memory coupled to the processor and storing instructions to cause the processor to:
generate frames on a stack for a chain of callers, each frame corresponding to one of the callers and at least some of the callers using an object that survives at least one but not all of the callers; and
retain at least one of the frames on the stack after the corresponding caller ceases to exist.

15. The system of claim 14, wherein all of the frames store data indicative of the object, the memory storing instructions to cause the processor to retain all of the frames until the final caller of the chain ceases to exist.

16. The system of claim 14, the memory storing instructions to cause the processor to generate another frame on the stack for an allocator that creates the object.

17. The system of claim 16, the memory storing instructions to retain said another frame on the stack after the allocator ceases to exist.

18. A method comprising:
generating compiled instructions to cause a computer to generate frames on a stack for a chain of callers, each frame corresponding to one of the callers and at least some of the callers using an object that survives at least one but not all of the callers; and
including at least prologue in the compiled instructions to cause the computer to retain at least one of the frames on the stack after the corresponding caller ceases to exist.

19. The method of claim 18, wherein all of the frames store data indicative of the object, the method further comprising:
including at least one additional prologue in the compiled instructions to cause the computer to de-allocate space for one of the frames corresponding to a final caller of the chain.

20. The method of claim 18, further comprising:
including a set of instructions in the compiled instructions to generate another frame on the stack for an allocator that creates the object.
